(19) United States
(12) Patent Application Publication
(10) Pub. No.: US 2001/0045943 A1
(43) Pub. Date: Nov. 29, 2001

(54) Display method and system

(76) Inventor: Olivier F. Prache, Pleasantville, NY (US)

Correspondence Address: COLLIER, SHANNON, SCOTT, PLLC, 3050 K STREET, NW, SUITE 400, WASHINGTON, DC, 20007, US

(21) Appl. No.: 09/785,270

(22) Filed: Feb. 20, 2001

Related U.S. Application Data
(60) Provisional application No. 60/183,362, filed on Feb. 18, 2000.

(51) Int. Cl. G09G 5/00

(52) U.S. Cl. 345/204

(57) ABSTRACT

The present invention is directed to a method of reducing power consumption by a video display. The method employs time-based subsampling of an input video image, at a rate slower than that of conventional computer monitors. A control circuit allows frame-based, line-based and pixel-based subsampling. The slower rate is achieved by utilizing analog, digital or both analog and digital storage elements to hold the input video information for a time sufficient to prevent flicker and other degradation of the image.

### CROSS-REFERENCE TO RELATED APPLICATIONS

This application relates to and claims priority to U.S. Provisional Application Ser. No. 60/183,362, filed Feb. 18, 2000 and entitled “Method of Reducing Display Power Through Image Subsampling.” Applicant hereby asserts that it is a small entity as described under 37 C.F.R. § 127 and is therefore entitled to a reduction in fees associated with the filing of this application.

### FIELD OF THE INVENTION

The present invention relates generally to video displays. Particularly, the invention relates to video display power consumption.

### BACKGROUND OF THE INVENTION

Most displays attached to a computer are operated as a raster scan display. In a raster scan display device, the screen is assumed to consists of a two dimensional matrix. The displayed image is updated by sequentially passing an electron beam over horizontal lines of the matrix (Scan Lines) until every pixel of the matrix is updated. Raster scan systems use a memory buffer called a frame buffer (or refresh buffer). The data in the frame buffer is updated at least 60 times per second (60 Hz) so as to allow for displaying motion video. Accordingly, regardless of whether the image content has changed, the frame buffer, corresponding to a full screen, is updated every 1/60th of a second. This updating consumes valuable power, especially in portable devices. Therefore, there is a need for a method and system for reducing the power consumed by display devices.

### OBJECTS OF THE INVENTION

It is therefore an object of the present invention to provide a method of reducing the power required to operate a display.

It is another object of the present invention to reduce the overall systems costs for a video display.

It is still another object of the present invention to provide a lightweight video display.

It is yet another object of the present invention to provide a method of reducing power required to operate a display in connection with portable and/or wearable display systems.

It is a further object of the present invention to provide a method of sampling input video information that reduces the size and cost of batteries required for a video display.

It is still a further object of the present invention to provide a method of sampling input video information at a slower rate than conventional computer monitors.

It is a further object of the present invention to provide a method of selectively receiving input video information whereby the power consumption of the display is reduced.

It is yet a further object of the present invention to provide a system for image subsampling for a video display that is capable of being used in portable and/or wearable display system.

It is another object of the present invention to provide a system for image subsampling that is capable of maintaining compatibility with existing architectures and components in video displays in order to remain cost effective.

It is still another object of the present invention to provide a system for image subsampling for a video display that allows efficient storage and maintenance of image data between samplings.

It is yet another object of the present invention to provide a system for image subsampling for a video display that is frame-based.

It is a further object of the present invention to provide a system for image subsampling for a video display that is line-based.

It is still a further object of the present invention to provide a system for image subsampling for a video display that is pixel-based.

It is yet a further object of the present invention to provide a system for image subsampling for an active matrix video display.

It is another object of the present invention to provide a system for image subsampling for an active matrix video display having cost-effective data storage.

It is still another object of the present invention to provide a system for image subsampling for an active matrix video display having analog data storage.

It is yet another object of the present invention to provide a system for image subsampling for an active matrix video display having digital data storage.

It is a further object of the present invention to provide a system for image subsampling for an active matrix video display having both analog and digital data storage.

It is still a further object of the present invention to provide a system for image subsampling for a video display capable of storing image information long enough to prevent flicker and other image degradation.

It is yet a further object of the present invention to provide a system for image subsampling for a video display that is capable of permitting real-time information display.

It is another object of the present invention to provide a method of reducing power consumption in a video display while permitting real-time information display.

It is still another object of the present invention to provide a system for image subsampling for a video display that permits the low power mode to be switched in and out.

Additional objects and advantages of the invention are set forth, in part in the description which follows and, in part, will be apparent to one of ordinary skill in the art from the description and/or from the practice of the invention.

### SUMMARY OF THE INVENTION

In response to the foregoing challenge, Applicant has developed an innovative, economical video display device and method of sampling video input information.

Most computer displays are used for office environment applications that do not require real-time updating bandwidth. In particular, portable displays such as those used with portable computers (notebooks, laptops, personal digital assistants, etc.) are seldom used for real-time video purposes.

As display formats grow larger, the data bandwidth becomes faster and the power required to update the screen at 60 Hz (or higher) also increases. Most office-related applications rely on keyboard and mouse for input, leading to a much lower image update rate. A system taking advantage of this condition leads to a significant power consumption reduction, and therefore a longer life in battery-operated systems.

In the present invention, Applicant discloses a function that can be added to the display controller. The function allows the input video information to be sampled at a slower rate than the typical 60-85 HZ presently used in most computer monitors.

The present invention is accomplished by leveraging the densities offered by semiconductor processes. In order to sample the input information at a low rate, the display technology should be capable of holding the previous information long enough to prevent flicker and/or other degradation of the image. As contemplated in the present invention, a single silicon die includes: an array of pixel cells with storage, peripheral drivers to address and provide information to the array, an interface to sample the incoming video information (analog or digital or both) and a control circuit that allows subsampling to reduce overall system power consumption. By combining this function with an active matrix display design that includes a storage element (analog, digital, or both), the power savings can be implemented successfully and cost effectively.

The present invention builds the display on a silicon substrate that contains all the circuitry required to operate the display and store the image information. The present invention permits real-time video as well as low power/low update rate displays. The present invention achieves an overall reduction in power consumption. Although the image source is more complex, a simple reduction in sampling by half will reduce the power consumption of the interface and addressing circuitry almost as much.

Furthermore, the present invention results in a reduction in overall system costs. The reduction in power required by the display leads to a lower power requirement at the system level. Therefore, a smaller and cheaper battery can be used to achieve the same performance as is available today. Also, the present invention results in no loss of functionality. The low power mode can be switched in and out by users at their discretion, by employing a control logic.

The invention provides a method of sampling input video information in a video display device. The method includes the steps of providing an array of pixel cells with associated storage means disposed on a substrate, providing input video information to at least one peripheral driver, sampling the input video information with an interface, subsampling the input video information with a control circuit, addressing the input video information by the at least one peripheral driver to said array, storing the input video information for a time period sufficient to prevent image degradation, and displaying the input video information on a display.

The invention also provides a display apparatus for displaying input image data. The display apparatus includes a display generator, which is adapted to provide a display output by employing image data. The apparatus includes an image buffer coupled to the display generator, which is storing image data corresponding to the image data employed by the display generator. The apparatus also includes a reception circuit coupled to the image buffer. The reception circuit is receiving input image data, which is associated with a first data update rate. The reception circuit is adapted to selectively receive image data from said input image data at a second rate, which is lower than the first rate. The reception circuit is further adapted to update the image data in the image buffer with the selectively received image data whereby the power consumption of the display device is reduced by the selective receiving of the input image data.

The invention also provides a method for reducing the power consumed by a display device. The method includes receiving input image data into the display device, the input image data received at a first rate, selectively storing the input image date at a second rate, the second rate is lower than the first rate, whereby the storing of the image data at the second rate consumed less power than the storing of the image data at the first rate, and providing the selectively stored data to the display image generation portion of the display device.

### BRIEF DESCRIPTION OF THE DRAWINGS

FIG. 1 illustrates the structure of a display device of the invention, including a display generating portion, a memory module, a subsampling circuit, and a display data source;

FIG. 2 illustrates the structure of a subsampling circuit of the invention;

FIG. 3 illustrates the structure of a semiconductor substrate-based display device;

FIG. 4 is a flow diagram illustrating a frame subsampling operation;

FIG. 5 is a flow diagram illustrating a line subsampling operation; and

FIG. 6 is a flow diagram illustrating a pixel level subsampling operation.

### DETAILED DESCRIPTION OF THE PREFERRED EMBODIMENT

The structure and operation of an example display device is now described by referring to diagram and flow charts. The description is generally applicable to many structural implementations. Additionally, several variations of the disclosed methods are intended to be part of the invention.

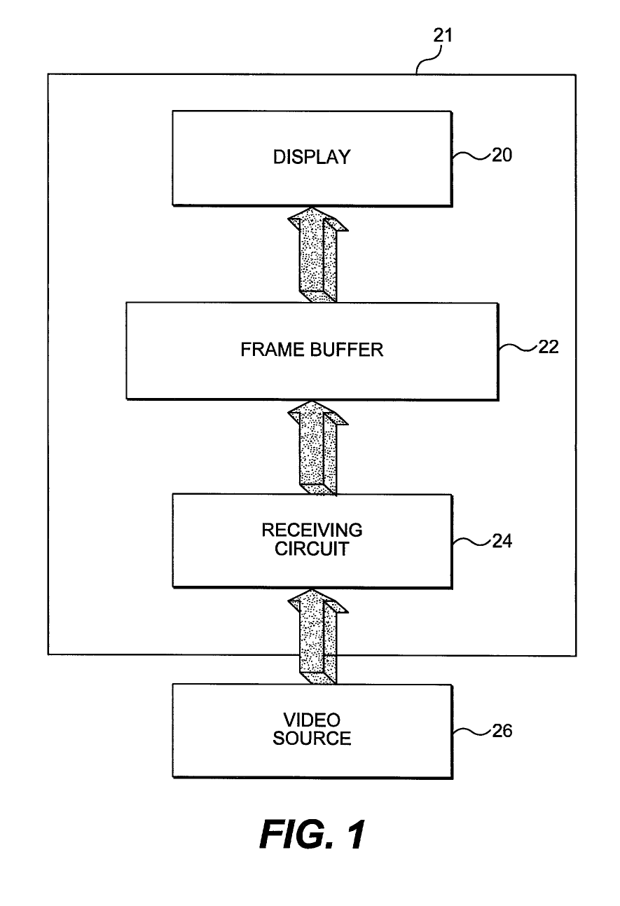

FIG. 1 is a diagram for the general structure of a display device of the invention. The display device 21 includes a receiving circuit 24, a frame buffer 22, and a display generator 20. The receiving circuit 24 preferably receives image data from a video generation module 26. Such modules 26 include a video graphics card, a video graphics processor, and a main processor executing video update instructions. The image data are usually provided to the receiving circuit 24 at a rate of one frame in at least every 1/60 of a second. Accordingly, to capture all the information for a frame of the display image, the data provided to the receiving circuit are stored over a period of less than 1/60 of a second. This storage of an entire frame requires a bandwidth that is sufficient to transmit data relating to all image pixels during 1/60 of a second. Typical display resolution requires in the order of 100 MHZ rates for properly updating the image data during this time.

The receiving circuit 24 is coupled to a frame buffer 22 that is used to store the image data, which is employed to generate the displayed image. The receiving circuit 24 is coupled to the display generator 20 to provide image data for generating a display image.

In operation, the receiving circuit 24 selectively receives image data from the video source 26. The selective receiving reduces the frequency of memory updates and therefore reduces the power consumed by the display device 21 as compared to a display that updates frame data at 60 HZ. The received data are then provided to the frame buffer 22. The data are then preferably provided to the frame buffer 22 at the input data rate (60 HZ). The display generator 20 reads the contents of the frame buffer 22 to generate a display image. In one implemention, the display generator 20 accesses the frame buffer at 60 HZ to operate as an ordinary raster type display.

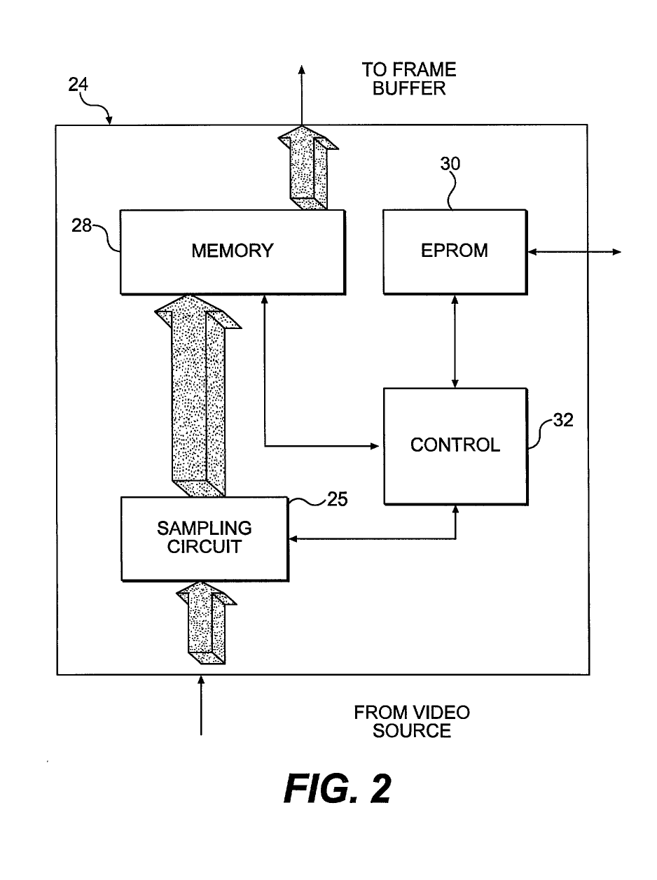

FIG. 2 is an illustration of the logical structure of the receiving circuit 24 that is used in the configuration that was described in FIG. 1. The receiving circuit 24 includes a data sampling circuit 25, a memory module 28, a control logic 32, and an EPROM 30. The sampling circuit 26 is coupled to the control logic 32 to receive control signals which control the operation of the sampling circuit. The sampling circuit 26 is further coupled to a memory module 28 to store the sampled image data. The control logic 32 is coupled to the memory module 28 and to the EPROM 30. The memory module 28 receives signals from the control logic 32, which control the transfer of memory content to the frame buffer. The EPROM 30 is used to store operating algorithm instructions that are used to guide the operation of the control logic 32.

In operation, the control logic 32 executes a control algorithm as specified by reference to the EPROM 30 contents. The control logic 32 directs the operation of the sampling circuit 26 to capture image data at a rate that is less than that at which the data are provided to the sampling circuit (e.g., 60 HZ). The captured data are then provided to the memory module 28. Preferably, after data for an entire frame are in the memory module 28, the data are provided to the frame buffer so as to update the image frame data.

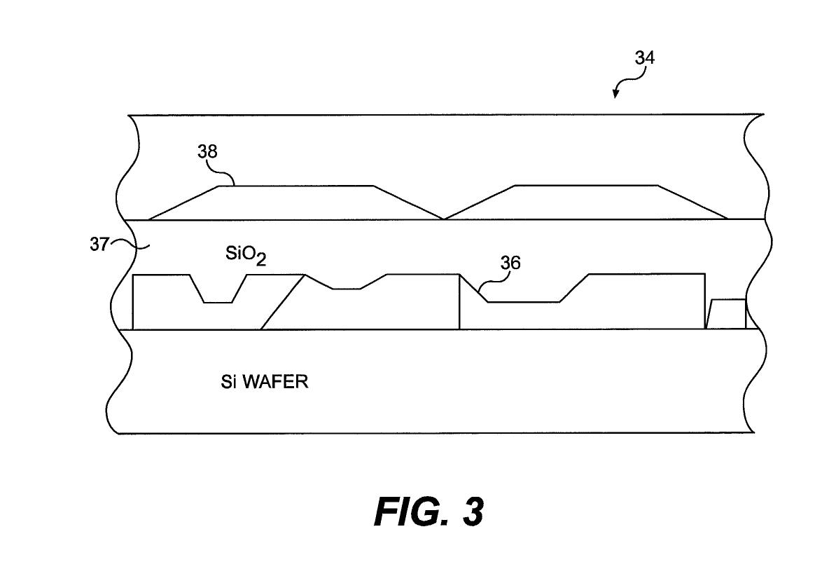

FIG. 3 illustrates the structure of a semiconductor based display device 34 that includes a receiving circuit, a frame buffer, and a display generator as part of a single silicon substrate. The integrated device includes a first semiconductor layer 36 that holds the logical components of the device. A second layer 37 is used to transport signals to a display layer 38. The display layer 38 includes a plurality of light emitting elements, preferably arranged as a matrix. The logical components store the image data that are used to direct control signals to power the individual emitting elements of the display layer 38.

In operation, the logical components in the first semiconductor layer 36 receive the input image data. A sampling circuit in the first layer 36 subsamples the input image data. The sampled image data are then provided to an interface controller that directs the image data to a memory module. The memory module is an array of storage elements that preferably stores data corresponding to each pixel in the display layer 38. The data from each storage element are then used to determine when to power corresponding pixels.

In accordance with the present invention, several methods of image subsampling are contemplated in order to reduce the power required for displays. All of the following methods subsample the input image data, each employing a specific algorithm.

### FRAME-BASED SAMPLING

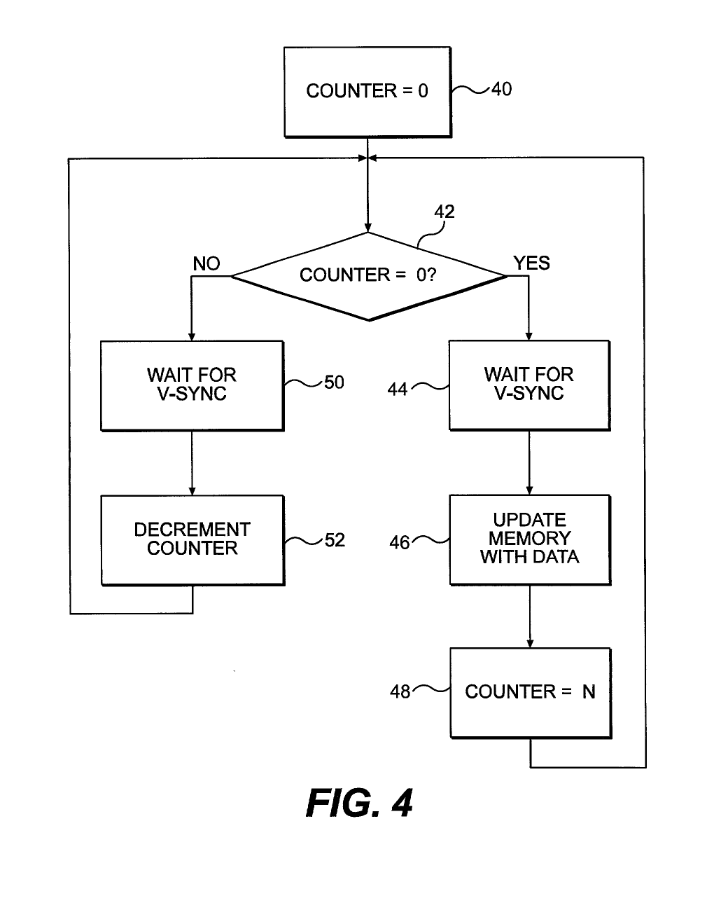

FIG. 4 is a flow diagram of an operational embodiment of the present invention, where the sampling of the input image data is accomplished on a per-frame basis. A frame-based subsampling of the input image data entails storing select frames of the input image data. Accordingly, the data in the display are updated every n frames instead of updating every frame. The value of n is selected by reference to the performance requirements for the display device. For example, the value of n is set higher in a system that does not receive moving image data than the setting in a system that frequently displays some form of moving image data. Furthermore, the value of n depends on the silicon process capabilities (leakage), as well as on the design of the pixels in the display and the display operation.

The example implementation of FIG. 4 uses one method to skip n frames from the received input frames. However, other methods can be used to skip frames. In one implementation, a counter is initialized to a value, which is zero in the example (step 40). The control logic determines whether the counter value is the starting value to which the counter was initialized (step 42). If the counter value is the starting value, the control logic waits to detect the vertical synchronization signal that indicates the start of an image frame (step 44). The data for the frame are then used to update the data in the memory buffer of the receiving circuit (step 46). The counter is then incremented by n units (step 48). In the example provided, the counter is directly set to n because the initial value was zero. When the counter value in step 42 is not the starting value (e.g. zero), the control logic waits for the vertical synchronization signal (step 50). However, at this point in the algorithm, the frame data are not used to update the memory buffer but rather are ignored. Instead, the control logic decrements the counter by one unit (step 52). As may be appreciated from this description, the algorithm has the effect of updating the memory buffer with frame data every n frames.

As may be appreciated, the average power saved grows as n grows. Assuming, for example, a typical keyboard entry updates the image at about 20 Hz, switching to the power saving mode (n=3) potentially reduces the average display addressing power by almost 3. The frame-based implementation does not change the existing display design architecture and therefore allows for backwards compatibility with existing display devices. The frame-based subsampling method requires full bandwidth during the sampling intervals because the entire frame data are sampled during a single iteration.

### LINE-BASED SAMPLING

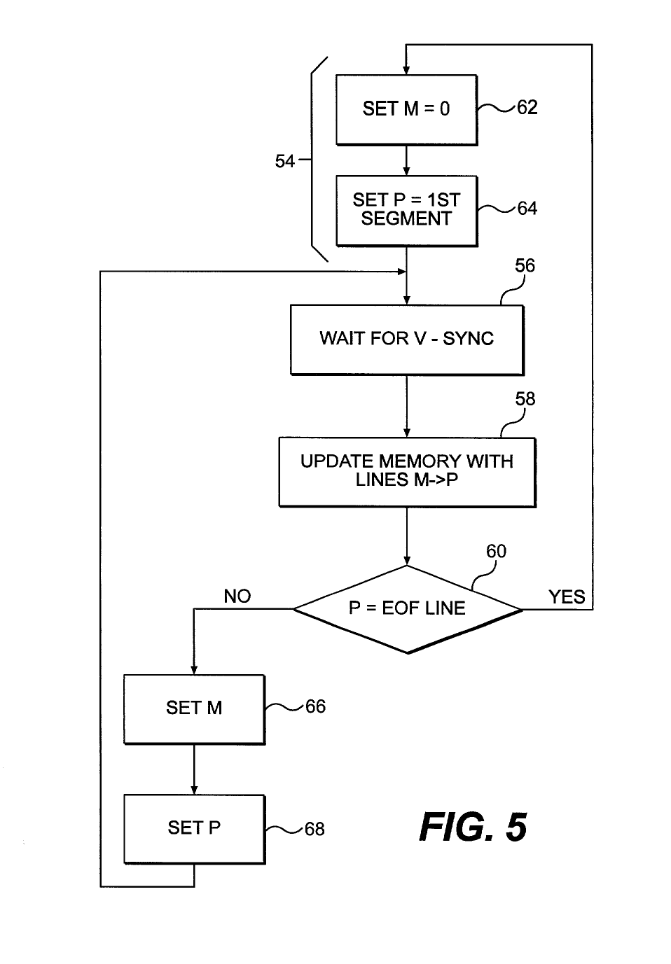

FIG. 5 is a flow diagram of another operational embodiment of the present invention, where the sampling of the input video information is accomplished on a line basis. In this embodiment, rather than sampling the information one frame at a time, the information is sampled over several frames, by selecting lines to be sampled from each received input frame. A counter is used to keep track of which lines are to be sampled during the next frame.

The control logic begins by initializing two variables, m and p, to a starting line number and an ending line number, respectively (step 54). Preferably, m is set to zero and p is set to the end of the first segment of lines. The control logic then waits for the vertical synchronization signal (step 56). When the signal is detected, the control logic directs the sampling circuit to receive data from the input frame corresponding to starting line m and ending line p (step 58). Accordingly, data for the selected lines are received into the memory buffer. The control logic then determines if the value of p is for the last line of the frame (step 60). If the value of p is the end of frame line, the control logic sets m back to zero and sets p to the end of the first segment of lines (steps 62, 64). If the value of p is not the end of frame line, the control logic sets m to one line over p and sets p to the end of the next segment of lines (steps 66, 68). The vertical synchronization signal is then detected and the process repeats. As may be appreciated, the determination of how many line to scan can be set by the programming of the control logic. Smaller line segments may suit devices where higher bandwidth is not available. Furthermore, select lines of the frame can be updated more frequently in devices that update some lines more frequently, such as cellular telephones. Also, this technique is advantageous for low information content displays, such as those used with personal digital assistants (PDAs), wireless phones or other personal communication devices, which typically receive information on a line-by-line basis over a longer time period than real-time displays.

### PIXEL-BASED SAMPLING

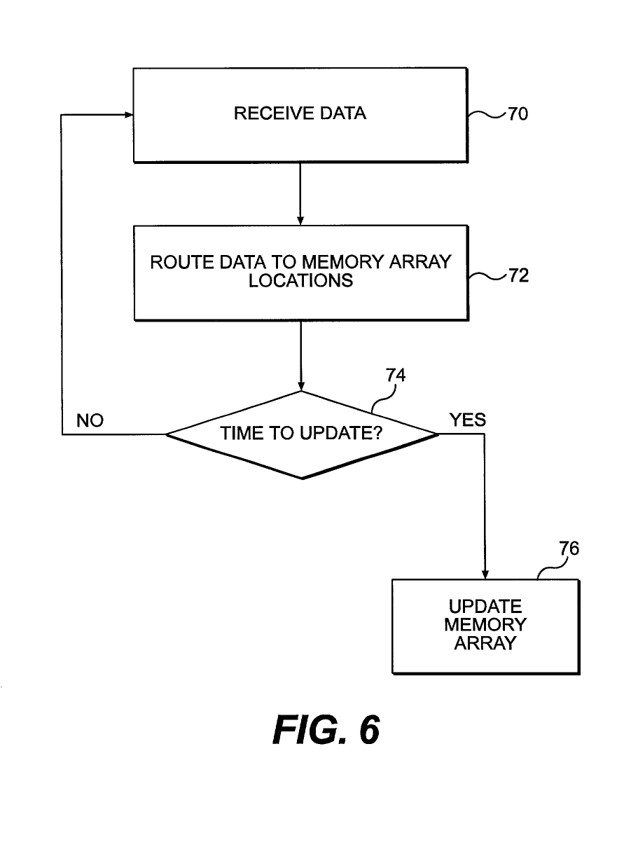

FIG. 6 is a flow diagram of another operational embodiment of the present invention, where the sampling of the input video information is accomplished on a pixel basis. The pixel-based sampling corresponds to display devices such as the device of FIG. 3, where a each pixel is associated with a memory element. In this approach, the display architecture is implemented as a memory array with an interface controller that routes the information to the appropriate area. The display can still appear as a raster-scanned display to the host by employing a peripheral driver for adressing the pixel array memory elements.

In the memory array configuration, each pixel cell is independently addressed as an individual element of the memory. The display pixel array includes row and column selection lines, which are controlled by an address decoder that resides within the display device. The display is thus addressed more like a random access memory (RAM) rather than as a raster scan display. The video data source for such a device provides a pixel address as well as a pixel data value, similar to how a microprocessor addresses a memory buffer. This allows updates to the display only where the source data has changed, and therefore further reduces the bandwidth and power requirements. This approach is most effective for bi-level displays where a simple static RAM cell is implemented at each pixel cell.

Referring back to FIG. 6, the receiving circuit receives input frame data from the display source (step 70). The data are then routed to the appropriate pixel memory location in accordance with the arrangement in the particular display device (step 72). The memory locations are updated as frequently as needed for the particular display device usage. When the control logic determines that an update is needed (step 74), the memory locations corresponding to the pixels are updated with corresponding data (step 76).

While this invention has been described in conjunction with specific embodiments thereof, it is evident that many alternatives, modifications and variations will be apparent to those skilled in the art. Accordingly, the preferred embodiments of the invention as set forth herein are intended to be illustrative, not limiting. Various changes may be made without departing from the spirit and scope of the invention.

What is claimed is:

1. A display apparatus for displaying input image data, comprising.
a display generator, the display generator adapted to provide a display output by employing image data;
a buffer coupled to the display generator, the buffer storing image data corresponding to the image data employed by the display generator; and
a reception circuit coupled to the image buffer, the reception circuit receiving input image data, the input image data associated with a first data update rate, the reception circuit adapted to selectively receive image data from the input image data at a second rate, the second rate is lower than the first rate, the reception circuit further adapted to update the image data in the buffer with the selectively received image data whereby the power consumption of the display device is reduced by the selective receiving of the input image data.

2. The apparatus of claim 1, wherein said buffer is selected from the group consisting of an analog storage element, and digital storage element, and both analog and digital storage elements.

3. The apparatus of claim 2, wherein said reception circuit selectively receives said input image data in increments of at least one frame.

4. The apparatus of claim 3, wherein said reception circuit gates said input image data based on occurrences of a vertical synchronization pulse.

5. The apparatus of claim 1, wherein said reception circuit selectively receives said input image data in increments of at least one line from a plurality of input image data frames.

6. The apparatus of claim 5, wherein said reception circuit further comprises a counter for tracking which of said at least one line is to be received.

7. The apparatus of claim 1, wherein said reception circuit selectively receives said input image data in increments of at least one pixel cell.

8. The apparatus of claim 7, further comprising a memory array for storing pixel cell data.

9. The apparatus of claim 7, wherein said at least one pixel cell comprises a static RAM cell.

10. The apparatus of claim 8, wherein said memory array further comprises an interface controller.

11. The apparatus of claim 9, wherein said interface controller routes said input image data to memory array elements corresponding to image pixels.

12. The apparatus of claim 1, wherein said reception circuit is adapted to alternatively receive the input image data at the first rate to provide a substantially real-time video display.

13. A display device, comprising:
an image generation module, the image generation module generating an image corresponding to image data;
a buffer, the buffer coupled to the image generation module, the buffer storing the image data; and
a sampling circuit, the sampling circuit subsampling image data by selectively receiving input image data into the buffer, whereby the subsampling of input data reduces the power consumption of the display device.

14. A low power display device for displaying input image data, comprising.
a silicon substrate;
a pixel array disposed on the substrate, the pixel array including a plurality of display pixels, the pixel array adapted to provide a display output by selectively powering each of said display pixels and by referring to image data corresponding to each of said display pixels;
a memory module, the memory module storing image data corresponding to each of said display pixels;
an interface controller, the interface controller adapted to facilitate the directing of image data corresponding to each of said display pixels to a corresponding memory location; and
a sampling circuit adapted to receive input image data, the sampling circuit selectively storing the input image data so as to sample the input image data at a reduced rate, the sampled image data provided to the driver module, whereby the driver circuit consumes less power by selectively sampling the input image data.

15. A method for reducing the power consumed by a display device, comprising:
receiving input image data into the display device, the input image data received at a first rate;
selectively storing the input image date at a second rate, the second rate is lower than the first rate, whereby the storing of the image data at the second rate consumed less power than the storing of the image data at the first rate; and
providing the selectively stored data to the display image generation portion of the display device.

16. A method for providing an image output from a display device while reducing power consumption, comprising:
providing a substrate that includes an array of pixels disposed on the substrate;
receiving input video data, the input video data provided at a first rate;
sampling the input data with a sampling interface, the sampling is at a second rate, the second rate lower than the first rate;
storing the sampled video data in a buffer, the buffer data employed to selectively power the array of pixels to deliver a video image; and
powering select pixels of the substrate, in accordance with the buffer data, to provide a video image.

17. A method for reducing power consumption in a video display device, comprising:
receiving input video data, the input video data corresponding to video image frames, the input video data provided at a first frame rate;
selectively updating a frame buffer with received input data, the selective updating facilitating a second frame rate, the second frame rate is lower than the first frame rate; and
displaying an image from the video display device by employing the data stored in the frame buffer.

18. A method for reducing power consumption in a video display device, comprising:
receiving input video data, the input video data corresponding to video image frames, each frame comprising data corresponding to a plurality of horizontal image lines, the input video data provided at a first frame rate;
selectively updating a display buffer with image line data from the received input data, the selective updating facilitated by replacing data in the display buffer with data from lines of an input frame;
storing a line update indicator, the line update indicator employed to identify lines of input frames for updating in said selective updating of the display buffer; and
displaying an image from the video display device by employing the video data stored in the display buffer.

19. The method of claim 18, wherein the data corresponding to image frame lines are updated at the same rate for all image frame lines.

20. The method of claim 18, wherein data for a select set of image frame lines are updated at a higher rate than data for the remaining image frame lines.

21. A method for reducing power consumption in a video display device having a memory location associated with each pixel of the display device, comprising:
receiving input video data, the input video data corresponding to video image frames, the input video data provided at a first frame rate;
routing the input video data to memory locations of the display device by associating the input video data with pixels corresponding to the memory locations;
selectively updating the memory locations of the display device with the routed input video data; and
displaying an image from the video display device by employing the video data stored in the memory locations of the display device.

22. A video display device comprising:
a substrate;
an array of pixel cells disposed on said substrate;
means for storage of input video information, said means corresponding to said array of pixel cells;
at least one peripheral driver for addressing and providing said input video information to said array of pixel cells;
an interface for sampling said input video information, disposed on said substrate; and
means for subsampling said input video information, connected to said interface, wherein said subsampling means samples said input video information at a rate that reduces system power consumption.
